(19) United States
(12) Patent Application Publication
(10) Pub. No.: US 2017/0043317 A1
(43) Pub. Date: Feb. 16, 2017

(54) PROCESS FOR PREPARING AN ADSORBENT MATERIAL IN THE ABSENCE OF BINDER COMPRISING A HYDROTHERMAL TREATMENT STEP AND PROCESS FOR EXTRACTING LITHIUM FROM SALINE USING SAID MATERIAL

(71) Applicants: ERAMET, PARIS (FR); IFP ENERGIES NOUVELLES, RUEIL-MALMAISON (FR)

(72) Inventors: Malika BOUALLEG, VILLEURBANNE (FR); Fabien André Pierre BURDET, PLAISIR (FR); Romain Charles Joseph René SOULAIROL, PARIS (FR)

(21) Appl. No.: 15/306,026

(22) PCT Filed: Apr. 24, 2015
(86) PCT No.: PCT/EP2015/058973

§ 371 Date: Oct. 21, 2016

(30) Foreign Application Priority Data
Apr. 25, 2014 (FR) 14 53779

(51) Int. Cl. B01J 20/04; C01D 15/04; C01F 7/00; B01J 20/30; B01J 39/10

(52) U.S. Cl. CPC B01J 20/046; B01J 20/3007; B01J 20/3078; B01J 20/3085; B01J 39/10; C01F 7/002; C01D 15/04

(57) ABSTRACT

A method for preparing a crystallized solid material of formula LiCl.2Al(OH)₃.nH₂O with n being comprised between 0.01 and 10, includes mixing in an aqueous medium, at least one source of alumina and at least one source of lithium in order to obtain a suspension, filtering the resulting suspension obtained for obtaining a slurry, followed by drying the obtained slurry and shaping the dried slurry after the drying to obtain a shaped solid material. The shaping is carried out in absence of a binder followed by drying and a hydrothermal treatment to obtain the shaped crystallized solid material of formula LiCl.2Al(OH)₃.nH₂O. A method for extracting lithium from saline solutions uses the thereby prepared material.

### TECHNICAL FIELD

The present invention relates to the field of solid materials for adsorbing lithium. In particular, the present invention relates to a novel method for preparing a crystallized solid material and shaped for example as extrudates, of formula LiCl.2Al(OH)₃,nH₂O with n being comprised between 0.01 and 10, comprising at least one shaping step, for example by extrusion carried out in the absence of any binder and a final hydrothermal treatment step giving the possibility of increasing the mechanical resistance and strength of the material when the latter is put into contact with a brine solution or of a diluted solution and preferably in water.

The present invention also relates to a method for extracting lithium from the saline solutions using said crystallized solid material of formula LiCl.2Al(OH)₃,nH₂O with n being comprised between 0.01 and 10 prepared according to the novel preparation method according to the invention.

### PRIOR ART

Lithium ions coexist with massive amounts of metals such as for example alkaline metals, earth-alkaline metals, boron and sulfates, in particular in saline solutions such as brines. Thus, they should be the subject of economical and selective extraction from these saline solutions. Indeed, the chemical properties of lithium and of alkaline metals, preferably sodium (Na), and potassium (K) and earth-alkalines, preferably magnesium (Mg), calcium (Ca) and strontium (Sr), make the separation of these elements difficult.

Solid materials of formula LiCl.2Al(OH)₃,nH₂O with n being comprised between 0.01 and 10 are known for their use in adsorption/desorption phenomena of lithium ions and in particular in methods for extracting lithium from saline solutions. These not very stable structures would allow insertion of lithium atoms into the structure and thus extraction of the lithium.

Several operating procedures leading to solids which may selectively adsorb lithium were disclosed in the prior art. In all the cases, an aluminium trihydroxide Al(OH)₃ solid, prepared or commercially obtained, is put into contact with a lithium precursor. Three main precursors are used: the most used is lithium chloride (LiCl). A lithium hydroxide (LiOH) or a lithium carbonate (Li₂CO₃) may also be applied.

U.S. Pat. No. 6,280,693 describes a method for preparing an LiCl/Al(OH)₃ solid by adding an aqueous LiOH solution to a polycrystalline alumina hydrate in order to form LiOH/Al(OH)₃, and thus generate active lithium sites in the crystalline layers of the alumina without altering the structure thereof. The transformation of LiOH/Al(OH)₃ into LiCl/Al(OH)₃ is then achieved by adding diluted hydrochloric acid. The thereby prepared aluminia pellets are then used in a method for extracting lithium from brines at a high temperature. The method for extracting lithium, described in U.S. Pat. No. 6,280,693 uses the solid detailed above and comprises the following steps:
a) Saturating a bath of solid with a brine containing a lithium salt LiX, X being selected from halides, nitrates, sulfates and bicarbonates,
b) Displacing the impregnated brine with a concentrated NaX solution,
c) Eluting the LiX salt captured by the solid by passing a solution not saturated with LiX,
d) Displacing the impregnant with a concentrated solution of NaX, the steps a) to d) are then repeated at least once.

Patent RU 2 234 367 describes a method for preparing a solid of formula LiCl.2Al(OH)₃,nH₂O comprising a step for mixing aluminium trichloride (AlCl₃) and lithium carbonate (Li₂CO₃) in the presence of water at 40° C. The obtained residue is filtered and washed and then dried for 4 hours at 60° C. The thereby obtained solid is not shaped.

The obtained solid is used for extracting lithium contained in saline solutions by putting it into contact with water in order to remove a portion of the lithium and then by putting it into contact with a saline solution containing lithium. The thereby obtained static capacity is comprised between 6.0 and 8.0 mg of lithium per g of solid.

Patent CN1243112 describes a method for preparing a solid of formula LiCl.2Al(OH)₃,nH₂O comprising a step for precipitation of aluminium hydroxide microcrystals Al(OH)₃ by putting into contact AlCl₃ and sodium hydroxide NaOH, and then by putting said microcrystals in contact with a 6% lithium chloride LiCl solution at 80° C. for 2 hours followed by filtration, rinsing and drying in order to obtain a powder of LiCl.2Al(OH)₃,nH₂O provided with a non-ordered and amorphous structure. A solution of a macromolecular polymer selected from among fluorinated resins, polyvinyl chloride (PVC), chlorinated polyvinyl chloride (CPVC), ethylene perchlorate and cellulose acetate-butyrates (CAB) acting as a binder is then mixed with the LiCl.2Al(OH)₃,nH₂O powder in order to obtain a slurry which is then shaped by granulation followed by drying in air.

The use of such a solid in a method for extracting lithium from brines of salted lakes gives the possibility of obtaining a low Mg/Li ratio and a mother-liquor rich in lithium and compliant with production standards for lithium carbonates or chlorides.

An object of the present invention is to provide a solid material allowing selective extraction of lithium from brine, said solid material being of good quality, without any apparent defects and having good cohesion and good mechanical strength when the latter is put into contact with a brine solution or in water.

An object of the present invention is to provide a novel method for preparing such a solid material.

Another object of the present invention is to provide a method for extracting lithium from saline solutions using said solid material.

Another object of the present invention is to provide a solid material for applying a method for extracting lithium from saline solutions, wherein the solid material gives the possibility of limiting the generation of fine particles notably since the fine particles increase the pressure drop, promote generation of preferential paths and increase the renewal rate of the material upon passing brine through a bed of a material within a column.

The applicants have discovered a novel method for preparing a crystallized solid material of formula LiCl.2Al(OH)₃,nH₂O with n being comprised between 0.01 and 10, comprising a combination of a specific step and in particular the fact of carrying out both the step for shaping a slurry, in the absence of any binder, directly after a drying step operating under specific conditions, the shaping step being then followed by another drying step also operating under specific conditions, and then carrying out a final hydrothermal treatment step of the shaped materials gives the possibility of obtaining a crystallized solid material of formula LiCl.2Al(OH)₃,nH₂O of good quality, having good cohesion, without any apparent defects and also having a good mechanical strength of the material when the latter is put into contact with a brine solution or with a diluted solution and preferably in water.

### SUMMARY AND BENEFIT OF THE INVENTION

By <<material of formula LiCl.2Al(OH)₃.nH₂O>> is preferably meant a material essentially comprising or consisting of a crystallized phase of formula LiCl.2Al(OH)₃,nH₂O.

The object of the present invention is a method for preparing a crystallized solid material of formula LiCl.2Al(OH)₃,nH₂O with n being comprised between 0.01 and 10, said method comprising at least the following steps:

a) a step for mixing in an aqueous medium, at least one alumina source and at least one lithium source in order to obtain a suspension,

b) a step for filtering the suspension obtained in step a) in order to obtain a slurry,

c) a step for drying the slurry obtained at the end of step b), at a temperature comprised between 20 and 80° C. preferably for a period comprised between 1 h and 12 h,

d) a step for shaping said dried slurry, directly after the drying step c), said shaping step d) being carried out in the absence of any binder,

e) a step for drying the shaped material obtained at the end of step d) at a temperature comprised between 20 and 200° C., preferably for a period comprised between 1 and 20 hours,

f) a hydrothermal treatment step of the dried shaped material obtained at the end of step e), preferably at a temperature comprised between 50 and 200° C. and preferably for a period comprised between 30 mins and 2 hours.

In the whole continuation of the text, by binder is meant any organic or inorganic compound which may be added in the shaping step d), or any precursors of organic or inorganic compounds which may form an organic or inorganic binder in situ, under the conditions of the shaping step d).

An advantage of the preparation method according to the invention is to allow the obtaining of a shaped crystallized solid material of formula LiCl.2Al(OH)₃,nH₂O with n being comprised between 0.01 and 10, of good quality, without any apparent defects, and in particular having good cohesion as well as improved mechanical strength when the latter is put into contact with a brine solution or a diluted solution and preferably in water.

By <<shaped>>, is meant that the material is solid and has sufficient cohesion when the solid is put into contact with a brine solution so that it does not substantially loose its physical integrity, i.e. it substantially retains its shape. More specifically, a shaped solid in the sense of the invention covers a solid retaining its cohesion under the conditions for extracting lithium defined in the Examples.

The cohesion as well as the mechanical resistance of the shaped material, for example by extrusion, prepared according to the invention are tested via an accelerated ageing procedure on a stirring table, either in brine, or in water.

The stirring table performs a horizontal unidirectional movement of amplitude 4 cm at a velocity of 190 movements per minute. The shaped solids are then stirred for a total period of 168 h.

At the end of these 168 h, the shaped brine or water solid mixture is sifted with a grid of 315 μm. The shaped solids remaining on the sieve are then washed with the medium used during the stirring. The thereby obtained liquid fraction, containing fine solid particles (diameter of less than 315 μm) in suspension, is filtered by means of a Buchner equipped with a paper filter for which the pores have a dimension of 0.45 μm. The cake formed by the agglomeration of the fine particles is washed with demineralized water. The thereby obtained solid residue is dried in an oven at 50° C. until stabilization of the mass.

The ratio of the solid residue mass over the initial shaped solid mass is then calculated, giving access to a destruction percentage of the shaped solids.

The destruction percentage of the materials prepared according to the invention gives the possibility of appreciating the cohesion of said materials.

Good cohesion is notably obtained for materials for which the destruction percentage is less than 60%, and preferably less than 50%, when the latter are put into contact with a brine solution or with any other diluted solutions and in particular with water.

The materials prepared according to the invention moreover have improved mechanical strength as compared with the materials of the prior art.

By “improved mechanical strength”, is meant that the materials prepared according to the invention have a destruction percentage, when they are put into contact with a brine solution or with any other diluted solutions and in particular with water, of less than 40% and preferably less than 30%.

Another advantage of the preparation method according to the invention is to give the possibility of obtaining a shaped crystallized solid material, for example as extrudates, of formula LiCl.2Al(OH)₃,nH₂O with n being comprised between 0.01 and 10, having no or few cracks which may cause swelling which is detrimental to the cohesion and to mechanical strength of the material when the latter is put into contact with a brine solution or with a diluted solution and preferably in water.

The object of the present invention is also a method for extracting lithium from saline solutions using said shaped crystallized solid material of formula LiCl.2Al(OH)₃,nH₂O with n being comprised between 0.01 and 10, prepared according to the novel preparation method according to the invention.

An advantage of the extraction method according to the invention is to allow selective extraction of lithium from a saline solution and thereby obtain a high purification factor relatively to the initial saline solution, calculated as being the X/Li ratio which is equal to the molar ratio of X/Li concentrations in the initial saline solution divided by the molar ratio of X/Li concentrations in the final solution, X being selected from sodium (Na), potassium (K), magnesium (Mg), calcium (Ca), boron (B), sulfur (S) and strontium (Sr).

The object of the present invention is also a crystallized solid material of formula LiCl.2Al(OH)₃,nH₂O with n being comprised between 0.01 and 10, for example as extrudates, which may be obtained according to a method of the invention.

The object of the present invention is also a device for extracting lithium from saline solution(s). The device according to the invention thus applies the extraction method according to the invention.

### DESCRIPTION OF THE INVENTION

According to the invention, at least one source of alumina and at least one lithium source are mixed in an aqueous medium in order to obtain a suspension in step a).

Preferably, the alumina source is aluminium trihydroxide Al(OH)₃.

The aluminium trihydroxide Al(OH)₃ may advantageously be a commercial product.

Preferably, aluminium trihydroxide Al(OH)₃ is prepared by precipitation of aluminium trichloride (AlCl₃) and of soda (NaOH).

In this case, said source of alumina and preferably aluminium trihydroxide Al(OH)₃ is prepared beforehand for mixing with at least one lithium source. Aluminium trichloride AlCl₃ and soda NaOH are advantageously mixed in the presence of water in order to form a precipitate which is advantageously filtered and washed at least once. The obtained precipitate is then mixed according to step a) with at least one lithium source in order to obtain a suspension.

The lithium source(s) may be any compound comprising the element lithium and being able to release this element in an aqueous solution in a reactive form. Preferably, the lithium source(s) is(are) selected from lithium salts and preferably from among lithium chloride (LiCl), lithium hydroxide (LiOH), lithium nitrate (LiNO₃), lithium sulfate (Li₂SO₄) and lithium carbonate (Li₂CO₃), taken alone or as a mixture.

Most preferably, the lithium source is lithium chloride (LiCl).

Preferably, at least one source of alumina and at least one lithium source are mixed in the presence of water in order to obtain a suspension in step a). Preferably, said mixing step a) operates under intensive stirring.

Preferably, said mixing step a) is applied at a temperature comprised between 40 and 120° C. and preferably between 60 and 100° C., preferably for a period comprised between 1 hour and 10 hours, preferably between 1 and 8 hours, preferably between 1 and 6 hours and more preferably between 1 and 3 hours.

According to the invention, the obtained suspension at the end of step a) undergoes a filtration step b) in order to obtain a slurry.

Preferably, the filtration is achieved on a Buchner filter, with displacement of water.

According to the invention, the obtained slurry at the end of step b) is dried in a drying step c) at a temperature comprised between 20 and 80° C., for a period for example comprised between 1 h and 12 h.

Preferably, said drying step operates preferably in an oven, at a temperature comprised between 20 and 60° C. and most preferably between 30 and 50° C., for a period for example comprised between 1 h and 10 h.

The operating conditions of said drying step c) give the possibility of obtaining a dried slurry having a fire loss (FL) comprised between 45 and 75% and preferably between 50 and 70%. The obtained fire loss gives the possibility of shaping for example by extrusion of the dried slurry under good conditions and the obtaining of resistant and defect-free extrudates, i.e. without any cracks.

In order to determine the FL before the shaping step, a portion of the obtained slurry is sampled and put in an oven for 6 h at 120° C. The FL is obtained by difference between the mass of the sample before and after passing in the oven.

According to the invention, said dried slurry obtained at the end of the drying step c) undergoes, directly after the drying step c), a shaping step d), said shaping step being carried out in the absence of a binder.

Preferably, said shaping step d) is carried out in the absence of binders selected from inorganic binders, such as for example hydraulic binders or inorganic binders which may be generated under the conditions of said step d) by adding precursors of inorganic binders, and organic binders, such as for example paraffins or polymers.

Advantageously, the solid material according to the invention does not comprise any binder, notably selected from among inorganic binders and organic binders. Preferably, said shaping step d) is carried out according to methods known to one skilled in the art, such as for example by extrusion, by tableting, by the drop coagulation method (oil-drop), by granulation with a rotating plate.

Most preferably, said shaping step d) is carried by extrusion.

In the case when said step d) is carried out by extrusion, said dried slurry does not undergo any intermediate steps between said drying step c) and said shaping step d) by extrusion, preferably no kneading step and more preferably no acid/basic kneading step.

Thus, more preferably, said shaping step d) by extrusion is carried out without addition of any acid or base to the dried slurry introduced in said step d).

Said step d) for shaping by extrusion is advantageously carried out in a known way to one skilled in the art.

In particular, the dried slurry from the drying step c) advantageously passes through a die, for example by means of a piston or a twin-screw or single-screw continuous extruder. The diameter of the die of the extruder is advantageously variable and is comprised between 0.1 and 5 mm, preferably between 0.2 and 3 mm and preferably between 0.3 and 2 mm. The shape of the die, and therefore the shape of the material obtained as an extrudate, is advantageously cylindrical, and may for example be of a circular, annular, three-lobed, four-lobed or else multilobed section. The solid material shaped according to the invention may thus have such characteristics. Notably the shaped solid material has a section or diameter substantially equivalent to that of the die of the extruder, and advantageously comprised between 0.1 and 5 mm, preferably between 0.2 and 3 mm and preferably between 0.3 and 2 mm. Thus the shaped material according to the present invention may be thread-like with a length for example comprised between 1 and 10 cm, and further for example between 2 and 6 cm. The shape may be hollow (tubular) or solid.

According to the invention, the shaped material and therefore the extrudes obtained at the end of step d) undergo a drying step e) at a temperature comprised between 20 and 200° C. for a period preferably comprised between 1 hour and 20 hours, in order to obtain the shaped crystallized solid material of formula LiCl.2Al(OH)₃,nH₂O, for example as extrudates.

Preferably, said drying step e) is applied at a temperature comprised between 20 and 100° C., preferably between 20 and 80° C. and most preferably between 20 and 60° C., for a period comprised between 1 and 18 hours, preferably between 5 and 14 hours and preferably between 8 and 14 hours.

The specific conditions of said drying step e) give the possibility of obtaining a crystallized solid material having the desired phase LiCl.2Al(OH)₃,nH₂O.

Said drying step e) is advantageously carried out according to techniques known to one skilled in the art and preferably in an oven.

According to the invention, the dried shaped material and for example the extrudates obtained at the end of step e) is(are) subject to a hydrothermal treatment step preferably at a temperature comprised between 50 and 200° C. and preferably for a period comprised between 30 mins and 12 hours.

Preferably, said step f) is applied at a temperature comprised between 70 and 200° C., preferably between 70 and 180° C., and most preferably between 80 and 150° C., for example for a period comprised between 30 minutes and 120 hours.

Said hydrothermal treatment step f) is advantageously carried out according to a technique known to one skilled in the art.

According to a preferred embodiment, said step f) is carried out in an autoclave, under autogenous pressure, and under an atmosphere saturated with water. Preferably, said step f) is carried out by introducing a liquid at the bottom of the autoclave, said liquid being selected from among water, alone or mixed with at least one acid, one base or a lithium salt. Preferably, the shaped and dried material, for example the extrudates, obtained at the end of step e) are not in contact with the liquid at the bottom of the autoclave.

In the case when water is introduced into the autoclave in a mixture with an acid, the acid is advantageously selected from among nitric acid, hydrochloric acid, sulfuric acid and carboxylic acid.

In the case when water is introduced into the autoclave in a mixture with a base, the base is advantageously selected from lithium hydroxide, sodium hydroxide, potassium hydroxide and ammonia.

In the case when water is introduced into the autoclave in a mixture with a lithium salt, the lithium salt is advantageously selected from among lithium chloride and lithium carbonate.

Preferably, said step f) is applied in the presence of a humid atmosphere comprising a water content comprised between 20 and 100% by weight, and preferably between 50 and 100% by weight, and preferably between 80 and 100% by weight.

According to an embodiment, said step f) may be carried out in a weathering oven, in the presence of a humid air flow containing between 20 and 100% by weight of water, preferably between 50 and 100% by weight and preferably between 80 and 100% by weight of water, or in an oven operating under a humid air flow containing between 20 and 100% by weight of water, preferably between 50 and 100% by weight and preferably between 80 and 100% by weight of water according to methods known to one skilled in the art.

The hydrothermal treatment step f) under a controlled atmosphere gives the possibility of obtaining a crystallized solid material of formula LiCl.2Al(OH)₃,nH₂O with n being comprised between 0.01 and 10, for example shaped as extrudates, having good strength and good mechanical resistance when the latter is placed in contact with a brine or a diluted solution and preferably water.

At the end of said step f), the obtained shaped material for example as extrudates is then advantageously recovered and may optionally be washed.

Said shaped material, for example the extrudates, obtained at the end of step f) may then be optionally subject to a drying step g), said drying step preferably operating at a temperature comprised between 15 and 50° C. for a period for example comprised between 1 h and 12 hours in order to obtain the shaped crystallized solid material of formula LiCl.2Al(OH)₃,nH₂O.

Said drying step g) is advantageously carried out according to techniques known to one skilled in the art, and preferably in an oven.

The method according to the present invention therefore gives the possibility of obtaining a crystallized solid material of formula LiCl.2Al(OH)₃,nH₂O with n being comprised between 0.01 and 10, preferably between 0.1 and 5 and preferably between 0.1 and 1, for example as extrudates with a section or diameter comprised between 0.2 and 5 mm, preferably between 0.3 and 4 mm, preferably between 0.3 and 3 mm, most preferably between 0.3 and 2 mm and still more preferably between 0.3 and 1.8 mm.

The best results in terms of mechanical strength and cohesion of the crystallized solid material obtained according to the preparation method according to the invention are obtained in the case of extrudates with a section or diameter comprised between 0.2 and 5 mm and preferably comprised between 0.3 and 1.8 mm, said extrudates having been obtained by the combination of a specific shaping step as described above and of a final drying step e) at a temperature comprised between 20 and 200° C., preferably comprised between 20 and 60° C. and in particular at 40° C., for a period comprised between 1 and 20 hours, preferably comprised between 5 and 14 hours, preferably between 8 and 14 hours and in particular for 8 hours.

The shaped crystallized solid material of formula LiCl.2Al(OH)₃,nH₂O, for example as extrudates, prepared according to the sequence of steps a), b), c), d) e), f) and g) of the preparation method according to the invention may be characterized according to the following techniques: nitrogen adsorption for determining the specific surface area according to the BET method; X-ray diffractometry, in the range of a diffraction angle 2□=0.8 to 40°±0.02° in a reflection geometry in order to identify the structure of said material and the elementary analysis.

The crystallized solid material of formula LiCl.2Al(OH)₃,nH₂O shaped, for example as extrudates, advantageously has a specific surface area measured according to the BET method comprised between 1 and 30 m²/g and preferably between 1 and 20 m²/g.

The X-ray diffraction diagram of the crystallized solid material of formula LiCl.2Al(OH)₃,nH₂O with n being comprised between 0.01 and 1, preferably between 0.1 and 0.5 and preferably between 0.1 and 0.4, obtained according to the invention, shaped, advantageously as extrudates, is characteristic of a non-amorphous material and has at least the following lines:

| 2θ | d (Å) |
|---|---|
| 11.505 | 7.69 |
| 20.195 | 4.39 |
| 23.065 | 3.85 |
| 35.937 | 2.50 |
| 39.948 | 2.26 |
| 55.406 | 1.66 |
| 63.243 | 1.47 |
| 64.349 | 1.45 |

A slight shift of these lines and of the intensity ratios may be observed. This only corresponds to the amount of inserted lithium and of chlorine atoms or water atoms inserted in the sheets, which differs. These slight differences do not have any impact on the good strength of the extrudates or on the adsorption capacities observed as described below.

The preparation method according to the present invention therefore gives the possibility of obtaining a shaped crystallized solid material of formula LiCl.2Al(OH)₃,nH₂O, for example as extrudates, having both a low specific surface area BET, good cohesion and having any apparent defect and exhibiting good strength and good mechanical resistance when the latter is placed in contact with a brine or a diluted solution and preferably in water.

The good properties of the obtained material result from the combined effect of shaping, for example by extrusion of a slurry, in the absence of any binder, directly, after a drying step operating under specific conditions, from the application of a drying step following the shaping, also operating under specific conditions and also from the application of a final hydrothermal treatment step preferably in an autoclave.

The object of the present invention is also a method for extracting lithium from a saline solution using said crystallized solid material of formula LiCl.2Al(OH)₃,nH₂O with n being comprised between 0.01 and 10, prepared according to the invention.

Said saline solution used in the extraction method according to the invention advantageously comprises a lithium concentration comprised between 0.001 mol/L and 0.5 mol/L, preferably between 0.02 mol/L and 0.3 mol/L.

Said saline solution also contains other species, such as for example the species selected from the following list: Na, K, Rb, Cs, Mg, Ca, Sr, Ba, F, Cl, Br, I, SO₄, CO₃, NO₃, and HCO₃. Said saline solution may advantageously be saturated with salts or not.

Said saline solution may be any natural saline solution, concentrated or stemming from a method for extracting or transforming lithium. For example, said saline solution used in the extraction method according to the invention may advantageously be selected from brines of salted lakes or of geothermal sources, the brines subject to evaporation in order to obtain brines concentrated in lithium, sea water, effluents of factories for producing cathodes, or for producing lithium chloride or hydroxide and effluents of the method for extracting lithium from minerals.

The method for extracting lithium according to the invention is preferably a selective method for extracting lithium. Indeed, it allows separation of lithium from alkaline metals, preferably sodium (Na), and potassium (K) and earth-alkaline metals, for example magnesium (Mg), calcium (Ca) and strontium (Sr), present in a massive amount in the saline solutions treated in said extraction method.

The method for extracting lithium according to the invention also allows selective separation of lithium from the other compounds such as boron and sulfates.

The method for extracting lithium according to the invention is advantageously applied in a unit comprising at least one column, said column(s) comprising at least one bed of said crystallized solid material of formula LiCl.2Al(OH)₃,nH₂O with n being comprised between 0.01 and 1, shaped and prepared according to the preparation method according to the invention.

Preferably, said method for extracting lithium according to the invention is applied in a unit comprising between one and six columns, and preferably between two and three columns, comprising at least one bed of the crystallized solid material of formula LiCl.2Al(OH)₃,nH₂O with n being comprised between 0.01 and 1.

Said method for extracting lithium advantageously comprises at least the following steps:
a step for activating said crystallized solid material of formula LiCl.2Al(OH)₃,nH₂O with n being comprised between 0.01 and 10,
a step for loading said material activated by adsorption achieved by the passing of said saline solution over said activated material,
at least one step for washing the saline solution impregnating said material by passing a washing solution over said material,
a step for desorption of lithium carried out by passing water or an aqueous solution of a lithium salt over said material in order to obtain an eluate comprising at least lithium.

Preferably, said step for activating the crystallized solid material of formula LiCl.2Al(OH)₃,nH₂O with n being comprised between 0.01 and 10, for example as extrudates, is carried out only once during putting of the synthesized material in a column and shaped according to the preparation method according to the invention.

Said activation step gives the possibility of activating the sites intended to selectively adsorb lithium.

Preferably, said activation step is advantageously carried out by the passing upwards or downwards, and preferably downwards of water or of a lithium salt solution having a concentration comprised between 0.001 mol/L and 0.1 mol/L, preferably between 0.001 mol/L and 0.05 mol/L and preferably between 0.01 and 0.04 mol/L.

Preferably, the lithium salt used in solution in said activation step is selected from among lithium chloride (LiCl), lithium nitrate and lithium bromide.

Most preferably, the lithium salt used in solution in said activation step is lithium chloride (LiCl).

According to a preferred embodiment, said activated crystallized solid material undergoes at the end of the activation step a washing step with a lithium chloride (LiCl) solution.

Said activation step is advantageously carried out at a temperature comprised between 0° C. and 90° C., and preferably between 10° C. and 60° C., and preferably between 10° C. and 30° C. at a flow rate comprised between 0.1 BV/h and 30 BV/h, and preferably between 1 BV/h and 15 BV/h.

The amount of solution required for activation is advantageously comprised between 1 BV and 30 BV, preferably between 2 BV and 20 BV.

By BV is meant the volume occupied by the bed of the solid in the column.

Said step for loading said material activated by adsorption is advantageously achieved by upward or downward passing and preferably downwards, of the saline solution treated in the extraction method according to the invention, on said activated material.

Said loading step is advantageously carried out at a temperature comprised between 0° C. and 90° C., and preferably between 10° C. and 70° C., at a flow rate comprised between 0.1 BV/h and 30 BV/h, and preferably between 1 BV/h and 15 BV/h.

The amount of solution required for saturating said material depends on the adsorption capacity of said material and on the lithium concentration of the saline solution.

The adsorption capacity of said material is comprised between 1 and 50, preferably between 1 and 30 and preferably between 1 and 10 mg of Li/g of dry solid material.

In the case when the method for extracting lithium according to the invention is applied in a unit comprising two columns, the first column is advantageously saturated with lithium during said loading step. The second column receiving the outward flow of the first column, is advantageously loaded until a lithium leak is obtained not exceeding 10% of the lithium concentration of the input flow and preferably 5%, thereby allowing maximization of the recovery yield of lithium.

In the case when said method for extracting lithium according to the invention is applied in a unit comprising three columns, the third column, already saturated with lithium, is dedicated to the washing and then desorption steps of lithium, described hereafter, during the loading of the two other columns.

The first fraction of the outward flow of said loading step by adsorption, advantageously between 0 BV and 1 BV, corresponds to the removal of the impregnant stemming from the stamp for activating the solid material. This fraction may be considered as an effluent or a recycled fraction, and preferably recycled as an input flow of the desorption step. In the case of the treatment of natural brine or of sea water, beyond 1 BV, the entirety of the output flow of said loading step by adsorption, called a raffinate hereafter which has not undergone any chemical treatment, is advantageously and preferably sent back to the original saline solution deposit.

At the end of the loading step by having the saline solution treated in the method according to the invention pass over the activated material, the saline solution impregnates said activated material.

The saline solution impregnating the activated material is then washed in at least one washing step by having a washing solution pass over said material.

Said washing step(s) of the saline solution impregnating said material, is(are) advantageously carried out by an upward or downward passing of a washing solution over said material, and preferably downwards.

Preferably, said washing solution is selected from water and an aqueous solution of a sodium salt and preferably of sodium chloride (NaCl), optionally comprising a lithium salt and preferably lithium chloride (LiCl), said solution advantageously having a sodium salt and preferably sodium chloride (NaCl) concentration, greater than 2 mol/L, preferably comprised between 2 mol/L and saturation and a lithium salt concentration and preferably of lithium chloride (LiCl), comprised between 0 mol/L and 2 mol/L.

According to a preferred embodiment, said saline solution impregnating the activated material undergoes a final washing step by having an aqueous washing solution of sodium chloride (NaCl) optionally comprising lithium chloride (LiCl) pass over said material.

Said washing step is advantageously carried out at a temperature comprised between 0° C. and 90° C., and preferably between 10° C. and 70° C., and at a flow rate comprised between 0.1 BV/h and 30 BV/h, and preferably between 1 BV/h and 15 BV/h. The amount of solution required for washing is comprised between 0.1 BV and 10 BV, typically in the range from 0.5 BV to 5 BV.

The outward flow of said washing step is considered as an effluent or is advantageously recycled, and preferably recycled to the inlet of the loading step or directly to the inlet of the second column in the case when said method for extracting lithium according to the invention is applied in a unit comprising at least two columns.

Said washing step gives the possibility of washing the saline solution impregnated in said material during the loading step of said material by adsorption, while limiting desorption of lithium.

In the case when said washing solution is an aqueous solution saturated with sodium chloride (NaCl), said washing step not only gives the possibility of removing the saline solution impregnated in said material during the step for loading said material by adsorption but also of desorbing the elements such as boron, sulfates, alkaline metals other than lithium and earth-alkaline metals.

The desorption step of lithium is then carried out by having water or an aqueous solution of lithium chloride (LiCl) pass over said material at the end of the washing step in order to obtain an eluate comprising at least lithium.

Preferably, said desorption step is carried out by upward or downward passing, and preferably downward passing of water or of a solution of lithium chloride (LiCl) containing from 0.001 mol/L to 2 mol/L of LiCl, and preferably from 0.01 mol/L to 1 mol/L.

Said desorption step is advantageously carried out at a temperature comprised between 0° C. and 90° C., and preferably between 10° C. and 70° C. at a flow rate comprised between 0.1 BV/h and 30 BV/h, and preferably between 1 BV/h and 15 BV/h.

The amount of lithium chloride (LiCl) solution required for desorption is advantageously comprised between 0.01 and 10 BV, and preferably between 0.05 BV and 5 BV.

The output flow of said desorption step for lithium generates the final product of the method, called an eluate.

The eluate is advantageously recovered between 0 BV and 4 BV, and preferably between 0.2 BV and 3 BV.

The whole of the other fractions of the output flow of this step not making up the final product called an eluate, is considered as an effluent or is advantageously recycled, and preferably recycled at the inlet of the washing step or of the loading step.

The eluate obtained at the end of the extraction method according to the invention is a solution in majority containing the elements Li, Na and Cl as well as impurities preferably selected from among K, Mg, Ca, Sr, B or SO₄.

The eluate is then advantageously concentrated and then purified in order to obtain a lithium salt with high purity.

Said method for extracting lithium according to the invention allows selective extraction of the lithium from a saline solution and thus gives the possibility of obtaining a high purification factor relatively to the initial saline solution, calculated as being the X/Li ratio which is equal to the X/Li concentration molar ratio in the initial saline solution divided by the X/Li concentration molar ratio in the eluate, X being selected from sodium (Na), potassium (K), magnesium (Mg), calcium (Ca), boron (B), sulfur (S) and strontium (Sr).

The present invention also covers a lithium extraction device characterizing that it comprises a unit comprising at least one column, said column comprising at least one packing comprising the crystallized solid material of formula LiCl.2Al(OH)₃,nH₂O with n being comprised between 0.01 and 10, preferably between 0.1 and 0.5 and preferably between 0.1 and 0.4, shaped, as defined according to the present invention.

More particularly, the invention covers a device applying the method for extracting lithium according to the invention. Still more specifically, the device of the present invention comprises units or means applying various steps of the method for extracting lithium according to the invention.

By “according to the invention” or equivalent terms, any embodiment, alternative, advantageous or preferred characteristic, taken alone or according to any of their combinations, are intended to be covered without any limitation.

### DESCRIPTION OF THE FIGURES

FIG. 1 illustrates the x-ray diffraction diagram of the solid material of formula LiCl.2Al(OH)₃,nH₂O obtained as extrudates in accordance with Example 5 according to the invention.

The invention is illustrated by the following examples which by no means have any limitation.

### EXAMPLES

### Example 1: (Comparative)

A solid material of formula LiCl.2Al(OH)₃,nH₂O with n being comprised between 0.01 and 1, is prepared according a synthesis method not compliant with the invention in that the step for shaping the obtained slurry is carried out according to the conventional acid/basic kneading extrusion technique, a technique applied according to the knowledge of one skilled in the art, and in that the method does not comprise any final hydrothermal treatment step.

1/ Synthesis of Al(OH)₃

In a beaker cooled with an ice bath, a solution containing 326 ml of permuted water and 135.6 g of aluminium chloride hexahydrate (AlCl₃) is prepared. Next, under magnetic stirring, 67.5 g of sodium hydroxide (NaOH) are slowly added. This cake is suspended in a 3 L beaker with 320 ml of water.

2/ Addition of Lithium Chloride LiCl.

A solution is prepared containing 78.5 g of lithium chloride LiCl provided by Prolabo and 1,326 ml of water which is added to the repulped cake. This reaction medium is stirred and heated to 80° C. for 2 h.

Filtration and drying in an oven at 80° C. for 8 h follow the first 2 steps.

The obtained dried slurry is then shaped according to the conventional technique of acid/basic kneading-extrusion. The dried slurry is introduced into a kneader of the Brabender type. The water acidified with nitric acid is added within 4 minutes, with kneading at 20 revolutions/min. The acid kneading is continued for 10 minutes. A neutralization step is then carried out by adding an ammonia solution in the kneader and kneading is continued for 3 minutes.

The kneading is carried out with a total acid level, expressed relatively to the dried slurry of 2%, and a neutralization level of 20%.

At the end of the kneading, no cohesive slurry was able to be obtained.

The obtained wet solid is shaped by means of a piston extruder (MTS), equipped with a cylindrical die with a diameter of 1 mm.

No intact extrudate was able to be obtained.

The obtained rings are very friable and do not have any cohesion in brine.

### Example 2 (Comparative)

A solid material of formula LiCl.2Al(OH)₃,nH₂O with n being comprised between 0.01 and 1, is prepared according to a synthesis method non-compliant with the invention in that the step for shaping the obtained slurry is carried out by kneading—extrusion in the presence of an inorganic binder from the family of hydraulic binders added during the kneading phase and in that the method does not comprise any final hydrothermal treatment step.

37.7 g of the solid material of formula LiCl.2Al(OH)₃,nH₂O with n being comprised between 0.01 and 1 are obtained according to the method described in Example 1 with the difference that the shaping step is carried out by kneading—extrusion in the presence of an inorganic binder.

The dried slurry obtained at the end of the first drying of Example 1 is introduced into a kneader of the Brabender type in the presence of 21.8 g of water and in the presence of 4.6 g of Dyckerhoff cement as a hydraulic binder and is simply kneaded.

The obtained slurry is shaped by means of a piston extruder (MTS), equipped with a cylindrical die with diameter of 1 mm.

The obtained extrudate at the end of the shaping step are then dried in an oven at 40° C. for 12 h.

The extrudates obtained at the end of the shaping step are also dried in a weathering oven at 25° C. for 48 h under air saturated with 98% of water.

Both drying methods led to the same result: the obtained extrudates are friable and exhibit many cracks.

### Example 3: (Comparative)

A solid material of formula LiCl.2Al(OH)₃,nH₂O with n being comprised between 0.01 and 1, is prepared according to a synthesis method not compliant with the invention in that the step for calcination of the extrudates is carried out according to the knowledge of one skilled in the art at a temperature above 500° C. and in that the method does not comprise any final hydrothermal treatment step.

1/ Synthesis of Al(OH)₃

In a beaker cooled by an ice bath, a solution containing 326 ml of permuted water and 135.6 g of aluminium chloride hexahydrate AlCl₃ is prepared. Next with magnetic stirring, 67.5 g of sodium hydroxide NaOH are added slowly. This cake is suspended in a 3 L beaker with 320 ml of water.

2/ Addition of Lithium Chloride LiCl.

A solution is prepared containing 78.5 g of lithium chloride LiCl provided by Prolabo and 1,326 ml of water which is added to the repulped cake. This reaction medium is stirred and heated to 80° C. for 2 h.

Filtration and drying in an oven at 40° C. for 8 h follow the first 2 steps.

The obtained slurry is directly shaped by means of a piston extruder (MTS), equipped with a cylindrical die with a diameter of 0.8 mm, without any prior kneading step. Extrudates exhibiting a correct aspect are obtained. These extrudates are calcined at 500° C. for 4 h.

The x-ray diffraction diagram of the extrudates of the solid material of formula LiCl.2Al(OH)₃,nH₂O obtained exhibits an undesired phase of the Li_{0.5}Al₂O₄ type which is a product from the decomposition of the LiCl.2Al(OH)₃,nH₂O phase.

### Example 4 (Comparative)

A solid material of formula LiCl.2Al(OH)₃,nH₂O with n=0.25 according to a synthesis method is prepared, in which the step for shaping the obtained slurry is directly carried out after the drying step, without any prior kneading step but not compliant with the invention in that the method does not comprise any final hydrothermal treatment step.

1/ Synthesis of Al(OH)₃

In a beaker cooled by an ice bath, a solution containing 326 ml of permuted water and 135.6 g of aluminium chloride hexahydrate (AlCl₃) is prepared. Next under magnetic stirring, 67.5 g of sodium hydroxide (NaOH) are slowly added. This cake is suspended in a 3 L beaker with 320 ml of water.

2/ Addition of the Lithium Chloride LiCl.

A solution is prepared containing 78.5 g of lithium chloride LiCl provided by Prolabo and 1,326 ml of water which is added to the repulped cake. This reaction medium is stirred and heated to 80° C. for 2 h.

Filtration and then drying in an oven at 40° C. for 8 h follow the first 2 steps.

The obtained slurry is directly shaped by means of a piston extruder (MTS), without any intermediate kneading step of said slurry. The piston extruder is equipped with a cylindrical die with a diameter of 0.8 mm. These extrudates are then dried at 40° C. for 12 h in an oven.

The obtained extrudates do not undergo any hydrothermal treatment step in an autoclave according to the invention.

Extrudates of the solid material of formula LiCl.2Al(OH)₃,nH₂O with n=0.25 having good cohesion and a correct aspect are obtained. A phase LiCl.2Al(OH)₃,nH₂O is detected on the x-ray diffraction diagram of the extrudates of the solid material of formula LiCl.2Al(OH)₃,nH₂O with n=0.25.

The obtained extrudates are also characterized by the following measurements:

Elementary analysis shows good Li/Al/Cl stoichiometry corresponding to the composition of a structure LiCl.2Al(OH)₃,nH₂O.

Al=21.2% by mass; Li=4.2% by mass; Cl=19% by mass.

The obtained extrudates have a specific surface area: S_{BET}=3 m²/g.

### Example 5 (According to the Invention)

A solid material of formula LiCl.2Al(OH)₃,nH₂O with n=0.25 is prepared according to a synthesis method according to the invention, wherein the step for shaping the obtained slurry is directly carried after the drying step, without any prior kneading step and wherein the obtained extrudates are subject to a final hydrothermal treatment step in the presence of water.

The extrudates are prepared like in Example 4 as far as the drying step in an oven at 40° C. for 12 h.

The obtained extrudates are then subject to a hydrothermal treatment step in an autoclave comprising water. 10 g of extrudates are placed in a basket placed in an autoclave of 500 ml. In the bottom of the autoclave are put 20 g of distilled water. The extrudates are not in contact with the liquid at the bottom of the autoclave.

The hydrothermal treatment is performed at a temperature of 100° C. for 6 h in an atmosphere saturated with water.

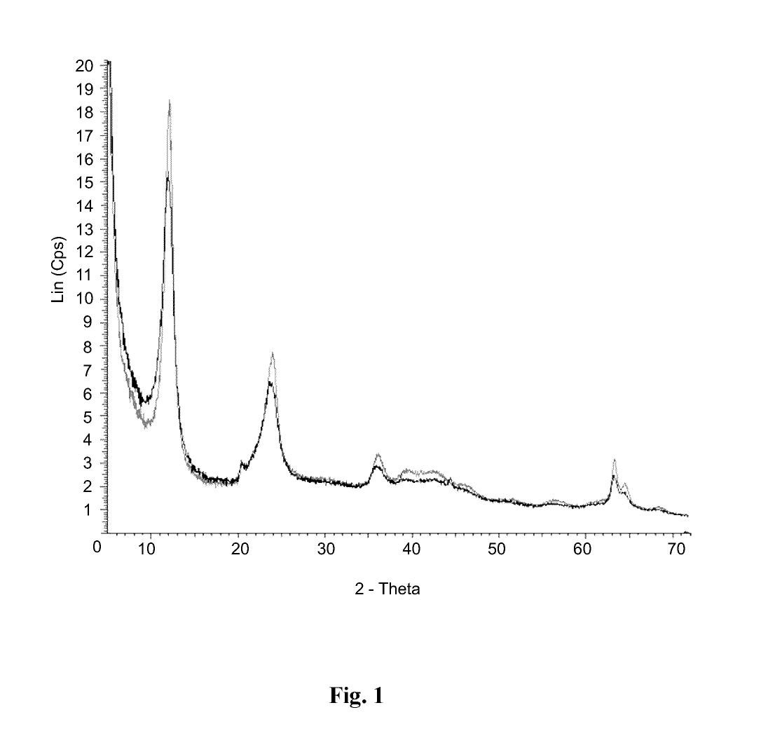

Extrudates of the solid material of formula LiCl.2Al(OH)₃,nH₂O with n=0.25 having good cohesion and a correct aspect are obtained. A phase LiCl.2Al(OH)₃,nH₂O is detected on the x-ray diffraction diagram of the extrudates of the solid material of formula LiCl.2Al(OH)₃,nH₂O with n=0.25 of FIG. 1.

The obtained extrudates are also characterized by the following measurements:

Elementary analysis shows good Li/Al/Cl stoichiometry corresponding to the composition of a structure LiCl.2Al(OH)₃,nH₂O.

Al=21.2% by mass; Li=4.2% by mass; Cl=19% by mass.

The obtained extrudates have a specific surface area: S_{BET}=3 m²/g.

### Example 6 (According to the Invention)

A solid material of formula LiCl.2Al(OH)₃,nH₂O with n=0.25 is prepared according to a synthesis method according to the invention, wherein the step for shaping the obtained slurry is directly carried out after the drying step, without any prior kneading step and wherein the obtained extrudates are subject to a final hydrothermal treatment step in the presence of a mixture of water and acid.

The extrudates are prepared like in Example 4 with the difference that the obtained extrudates are then subject to a hydrothermal treatment step in an autoclave comprising in its bottom a mixture of water and nitric acid in order to obtain a pH equal to 3. 10 g of extrudates are placed in a basket placed in a 500 ml autoclave. 20 g of acidified water are put in the bottom of the autoclave. The extrudates are not in contact with the liquid at the bottom of the autoclave.

The hydrothermal treatment is performed at a temperature of 100° C. for 8 h under an atmosphere saturated with water.

Extrudates of the solid material of formula LiCl.2Al(OH)₃,nH₂O with n=0.25 having good cohesion and a correct aspect are obtained. A phase LiCl.2Al(OH)₃,nH₂O is detected on the x-ray diffraction diagram of the extrudates of the solid material of formula LiCl.2Al(OH)₃,nH₂O with n=0.25.

The obtained extrudates are also characterized by the following measurements:

Elementary analysis shows good Li/Al/Cl stoichiometry corresponding to the composition of a structure LiCl.2Al(OH)₃,nH₂O.

Al=21.2% by mass; Li=4.2% by mass; Cl=19% by mass.

The obtained extrudates have a specific surface area: S_{BET}=3 m²/g.

### Example 7 (According to the Invention)

A solid material of formula LiCl.2Al(OH)₃,nH₂O with n=0.25 is prepared according to a synthesis method according to the invention, wherein the step for shaping the obtained slurry is directly carried out after the drying step, without any prior kneading step and wherein the obtained extrudates are subject to a final hydrothermal treatment step in the presence of a mixture of water and of a base.

The extrudates are prepared like in Example 4 with the difference that the obtained extrudates are then subject to a hydrothermal treatment step in an autoclave comprising in its bottom a mixture of water and of soda in order to obtain a pH equal to 11. 10 g of extrudates are placed in a basket placed in a 500 ml autoclave. 20 g of basic water are placed in the bottom of the autoclave. The extrudates are not in contact with the liquid at the bottom of the autoclave.

The hydrothermal treatment is performed at a temperature of 100° C. for 6 h under an atmosphere saturated with water.

Extrudates of the solid material of formula LiCl.2Al(OH)₃,nH₂O with n=0.25 having good cohesion and a correct aspect are obtained.

A phase LiCl.2Al(OH)₃,nH₂O is detected on the x-ray diffraction diagram of the extrudates of the solid material of formula LiCl.2Al(OH)₃,nH₂O with n=0.25.

The obtained extrudates are also characterized by the following measurements:

Elementary analysis shows good Li/Al/Cl stoichiometry corresponding to the composition of a structure LiCl.2Al(OH)₃,nH₂O.

Al=21.2% by mass; Li=4.2% by mass; Cl=19% by mass.

The obtained extrudates have a specific surface area: S_{BET}=3 m²/g.

### Example 8

### Cohesion and Mechanical Strength Test by Accelerated Ageing on a Stirring Table

The mechanical strength of the extrudates may be tested via an accelerated ageing procedure on a stirring table in two different media:
5 g of shaped solid material and 25 ml of natural brine are placed in a cylindrical container with a capacity of 60 ml. This container is attached to the stirring table during the whole period of the test.
The composition of the natural brine used during this test is given in Table 1.

TABLE 1
composition of the natural brine used
for the mechanical strength test

| | Na | K | Li | Mg | Ca | B | SO₄ | Sr | Cl |
|---|---|---|---|---|---|---|---|---|---|
| Concen- | 4.4 | 0.24 | 0.068 | 0.086 | 0.040 | 0.031 | 0.035 | 0.001 | 4.89 |
| tration | | | | | | | | | |
| (mol/L) | | | | | | | | | |

5 g of shaped solid material and 25 ml of water are placed in a cylindrical container with a capacity of 60 ml. This container is attached to the stirring table for the whole period of the test.

The stirring table performs a horizontal unidirectional movement with an amplitude of 4 cm at a speed of 190 movements per minute. The shaped solids are then stirred for a total period of 168 h.

At the end of these 168 h, the shaped solid mixture-brine is sifted by means of a grid of 315 μm. Next the shaped solids remaining on the sieve are washed with the medium used during the stirring (brine for which the composition is indicated in table 1 or water). The thereby obtained liquid fraction, containing fine solid particles (diameter of less than 315 μm) in suspension, is filtered by means of a Buchner equipped with a paper filter for which the pores have a dimension of 0.45 μm. The cake formed by the agglomeration of the fine particles is washed with demineralized water.

The thereby obtained solid residue is dried in an oven at 50° C. until stabilization of the mass.

The ratio of the solid residue mass over the mass of the initial shaped mass of solids is then calculated, giving access to a destruction percentage of the shaped solids.

The destruction percentage of the shaped solids gives the possibility of appreciating the cohesion of the solids as well as their mechanical strength. Good cohesion is notably obtained for solids for which the destruction percentage is less than 60%, and preferably less than 50%. Improved mechanical strength and resistance is notably obtained for solids for which the destruction percentage is less than 40%, and preferably less than 30%.

The mechanical strength of the extrudates obtained according to Examples 1 to 6 is tested in contact with a solution of natural brine and of water.

The various results are summarized in Table 2.

TABLE 2
applied shaping procedure and aspect of the corresponding extrudates

| | Examples | | | |
|---|---|---|---|---|
| | 1 (non-compliant) | 2 (non-compliant) | 3 (non-compliant) | 4 (comparative) |
| Shaping step (MEF) | Acid and basic | Kneading with a | Direct extrusion | Direct |
| | kneading + | cement binder + | | extrusion |
| | extrusion without | extrusion | | |
| | any binder | | | |
| Aspect of the | [symbol] Rings [symbol] which | Many cracks, | Extrudates | Visually intact |
| extrudates in contact | rapidly disintegrate | extrudates which | without any | extrudates |
| with brine | | become a powder | apparent defects | |
| Hydrothermal | no | no | no | no |
| treatment | | | | |
| XRD phase | — | — | Li_{0.5}Al₂O₄ | LiCl•2Al(OH)₃, |
| | | | | nH₂O |
| Brine cohesion test, | >60% | >60% | — | 40% |
| destruction % | | | | |
| Water cohesion test, | >60% | >60% | — | 50% |
| destruction % | | | | |

| | Examples | | |
|---|---|---|---|
| | 5 (compliant) | 6 (compliant) | 7 (compliant) |
| Shaping step (MEF) | direct extrusion | direct extrusion | direct extrusion |
| Aspect of the | Visually intact | Visually intact | Visually intact |
| extrudates in contact | extrudates | extrudates | extrudates |
| with brine | | | |
| Hydrothermal | Autoclave | Autoclave | Autoclave |
| treatment | Water | Water + acid | Water + base |
| XRD phase | LiCl•2Al(OH)₃, nH₂O | LiCl•2Al(OH)₃, nH₂O | LiCl•2Al(OH)₃, nH₂O |
| Brine cohesion test, | 15% | 15% | 15% |
| destruction % | | | |
| Water cohesion test | 25% | 25% | 25% |
| destruction % | | | |

The extrudates obtained according to the comparative example 4 and the compliant examples 5, 6 and 7 as compared with those according to non-compliant preparation methods with the invention, visually have good cohesion, have no or few cracks which may cause swelling detrimental to the cohesion and to the strength of the material when the latter is put into contact with a brine solution or water. Moreover, the extrudates produced according to the invention produce less fines during the mechanical strength test as compared with the extrudates produced according to the comparative example 4.

### Example 9 (According to the Invention)

test of the materials produced according to the comparative example 4 and the compliant examples 5, 6 and 7 in the method for extracting lithium according to the invention.

The material according to the invention prepared in Example 5 is introduced into a jacketed column in order to form a cylindrical bed with a diameter of 2.5 cm and a height of 30 cm.

The material is then activated at room temperature T=20° C. with a lithium chloride LiCl solution with a concentration of 0.02 mol/L in a downward flow at a flow rate of 3 BV/h. The total volume of LiCl solution used is 14 BV.

Once the activation step is completed, loading is carried out by means of a natural brine, the composition of which is given in Table 3.

TABLE 3
composition of the natural brine used for the loading

| | Na | K | Li | Mg | Ca | B | SO₄ | Sr | Cl |
|---|---|---|---|---|---|---|---|---|---|
| Concen- | 4.4 | 0.24 | 0.068 | 0.086 | 0.040 | 0.031 | 0.035 | 0.001 | 4.89 |
| tration | | | | | | | | | |
| (mol/L) | | | | | | | | | |

The loading of the activated material by adsorption is carried out by having the natural brine pass over said activated material, at a temperature of 60° C., the temperature being maintained by means of a circulation of heated water in the jacket, with a flow rate of 3 BV/h in an upward flow.

Under the conditions of the example, the adsorption capacity of the material is 4.7 mg of Li/g of dry solid material for a lithium recovery yield of 93%.

At the end of the loading, the washing step is practiced by using an aqueous solution of sodium chloride. This solution is prepared with saturation of sodium chloride NaCl at 20° C. The solution is then heated to 60° C. and passed at the same temperature as a downward flow in the column at a flow rate of 3 BV/h for a total amount of 4 BV.

Next, it is proceeded with the desorption step of the lithium by having a lithium chloride (LiCl) solution with a concentration of 0.02 mol/L pass over said material. This desorption is carried out at a temperature of 20° C. with a flow rate of 3 BV/h and in a downward flow. The eluate containing lithium is recovered between 0.75 and 2.25 BV.

The composition of the eluate as well as the resulting purification factors are summarized in Table 4.

TABLE 4
composition of the eluate and purification factors

| X | Na | K | Li | Mg | Ca | B | SO₄ | Sr | Cl |
|---|---|---|---|---|---|---|---|---|---|
| Composition | 0.52 | 3.3 · 10⁻⁴ | 0.11 | 8.6 · 10⁻³ | 4.3 · 10⁻³ | 1.0 · 10⁻³ | 9.4 · 10⁻⁵ | 8.0 · 10⁻⁶ | 0.66 |
| (mol/L) | | | | | | | | | |
| Purification | 10 | 1000 | — | 15 | 10 | 50 | 500 | 90 | 10 |
| factor | | | | | | | | | |

The concentrations of elements in the brine and in the eluate are determined by the optical ICP method known to one skilled in the art.

The CI concentrations in the eluate and the brine are determined by the ion chromatography method known to one skilled in the art.

The extraction method according to the invention therefore allows selective extraction of lithium from natural brine. The selectivity with respect to lithium is expressed as a purification factor which is equal to the X/Li molar ratio in the initial natural brine divided by the X/Li molar ratio in the eluate and which takes into account the external provision of lithium by the washing solution.

The obtained results indicate that the solid prepared according to the invention is particularly selective in potassium (K), in strontium (Sr), in boron (B) and in sulfates (SO₄).

The extrudates obtained according to the comparative Example 4 and the compliant Examples 5, 6 and 7 exhibit sufficient cohesion for a use in a column. Moreover, the materials prepared according to the invention generate less fines during their use. This property is an improvement since it gives the possibility of limiting the pressure drop, limiting the generation of preferential paths and reducing the renewal rate of the material.

1. A method for preparing a crystallized solid material of formula LiCl.2Al(OH)₃,nH₂O with n being comprised between 0.01 and 10, said method comprising at least the following steps:
a) mixing, in an aqueous medium, at least one source of alumina and at least one source of lithium thereby obtaining a suspension,
b) filtering the suspension obtained in a) thereby obtaining a slurry,
c) drying the slurry obtained at the end of b), at a temperature comprised between 20 and 80° C.,
d) shaping said dried slurry, directly after said drying of c), said shaping d) being carried out in the absence of any binder,
e) drying the shaped material obtained at the end of d) at a temperature comprised between 20 and 200° C.,
f) hydrothermally treating the shaped and dried material obtained at the end of e).

2. The method according to claim 1, wherein the source of alumina is aluminium trihydroxide Al(OH)₃.

3. The method according to claim 1, wherein the lithium source is selected from the group consisting of lithium chloride (LiCl), lithium hydroxide (LiOH), lithium nitrate (LiNO₃), lithium sulfate (Li₂SO₄), lithium carbonate (Li₂CO₃), and any mixture thereof.

4. The method according to claim 3 wherein the lithium source is lithium chloride (LiCl).

5. The method according to claim 1, wherein said mixing a) is performed at a temperature comprised between 40 and 120° C. for a period comprised between 1 hour and 10 hours.

6. The method according to claim 1 wherein said dried slurry does not undergo any intermediate steps between said drying c) and said shaping d).

7. The method according to claim 1, wherein said drying e) is performed at a temperature comprised between 20 and 100° C. for a period comprised between 1 hour and 18 hours.

8. The method according to claim 1, wherein said f) is performed at a temperature comprised between 80 and 150° C.

9. The method according to claim 1, wherein said f) is performed in the presence of a humid atmosphere having a water content comprised between 80 and 100% by weight.

10. A crystallized solid material of formula LiCl.2Al(OH)₃,nH₂O with n being comprised between 0.01 and 10, obtainable according to a method according to claim 1.

11. A method for extracting lithium from saline solutions using a solid material of formula LiCl.2Al(OH)₃,nH₂O with n comprised between 0.01 and 10, prepared according to the method as defined according to claim 1.

12. The extraction method according to claim 11, wherein said lithium extraction method comprises at least the following steps:
activating said crystallized solid material of formula LiCl.2Al(OH)₃,nH₂O,
loading said activated material by adsorption by passing said saline solution over said activated material thereby obtaining a loaded material,
washing the saline solution impregnating said loaded material by passing a washing solution over said loaded material thereby obtaining a washed material,
desorption of lithium by passing water or an aqueous solution of a lithium salt over said washed material thereby obtaining an eluate comprising at least lithium.

13. The extraction method according to claim 12, wherein said activation is carried out by the upward or downward passing of water or of a lithium chloride (LiCl) solution having a concentration comprised between 0.001 mol/L and 0.1 mol/L.

14. The extraction method according to claim 12, wherein said activation is carried out at a temperature comprised between 0° C. and 90° C., and at a flow rate comprised between 0.1 BV/h and 30 BV/h, wherein BV/h means the volume occupied by the bed of the solid in a column, per hour.

15. The extraction method according to claim 12, wherein said loading is carried out at a temperature comprised between 0° C. and 90° C., and at a flow rate comprised between 0.1 BV/h and 30 BV/h, wherein BV/h means the volume occupied by the bed of the solid in a column, per hour.

16. The extraction method according to claim 12, wherein said washing solution is water or an aqueous solution of sodium chloride (NaCl), optionally comprising lithium chloride (LiCl).

17. The extraction method according to claim 12, wherein said washing is carried out at a temperature comprised between 0° C. and 90° C., and at a flow rate comprised between 0.1 BV/h and 30 BV/h, wherein BV/h means the volume occupied by the bed of the solid in a column, per hour.

18. The extraction method according to claim 12, wherein said desorption is carried out by upward or downward passing of water or of a solution of lithium chloride (LiCl) containing from 0.001 mol/L to 2 mol/L of LiCl.

19. The extraction method according to claim 12, wherein said desorption is carried out at a temperature comprised between 0° C. and 90° C., and at a flow rate comprised between 0.1 BV/h and 30 BV/h, wherein BV/h means the volume occupied by the bed of the solid in a column, per hour.

20. A lithium extraction device characterizing that it comprises a unit comprising at least one column, said column comprising at least one pattern comprising the crystallized solid material of formula LiCl.2Al(OH)₃,nH₂O with n being comprised between 0.01 and 10, shaped obtainable according to a method according to claim 1.
